(19) United States
(12) Patent Application Publication
(10) Pub. No.: US 2017/0064287 A1
(43) Pub. Date: Mar. 2, 2017

(54) FAST ALGORITHM FOR ONLINE CALIBRATION OF RGB-D CAMERA

(71) Applicant: Alexander Borisov, San Jose, CA (US)

(72) Inventor: Alexander Borisov, San Jose, CA (US)

(73) Assignee: Itseez3D, Inc., San Jose, CA (US)

(21) Appl. No.: 15/244,159

(22) Filed: Aug. 23, 2016

Related U.S. Application Data
(60) Provisional application No. 62/209,170, filed on Aug. 24, 2015.

(51) Int. Cl. H04N 13/02; G06T 15/50; G06T 15/04; G06T 15/20; H04N 13/00; G06T 17/20

(52) U.S. Cl. CPC H04N 13/0246; H04N 13/0022; H04N 13/021; H04N 13/0257; G06T 17/20; G06T 15/04; G06T 15/20; G06T 15/503

(57) ABSTRACT

The present invention provides a method of producing a 3-dimensional model of a scene.

### CROSS REFERENCE TO RELATED APPLICATIONS

This application claims the benefit of U.S. Provisional Application No. 62/209,170, filed Aug. 24, 2015, the entire content of which is incorporated by reference.

### BACKGROUND OF THE INVENTION

### Field of Invention

The present invention relates to calibration in the context of computer vision, which is a process of establishing the internal parameters of a sensor (RGB camera or a depth sensor) as well as relative spatial locations of the sensors to each other.

Most of the state of the art algorithms [3, 4] assume that all the data is acquired with the same intrinsic/extrinsic parameters. However, it is found that both internal sensor parameters as well as their relative location changes from run to run resulting in a noticeable degradation in the final result.

Good calibration is crucial both for obtaining a good model texture and for RGBD odometry quality. There is no evidence that this problem can be solved with calibration done in advance or even by optimizing camera positions and calibration parameters at the same time with SBA using combined RGB reprojection error and ICP point-to-plane distance cost function similar to [4]. Error in intrinsic and extrinsic parameters leads to a misalignment of texture with a geometric model. The goal of our research was to create an algorithm that a) allows online RGBD calibration that improves with each shot taken, provides maximum quality and robustness given few images or even one image. b) use it for improvement of offline SLAM to find the most accurate calibration parameter values and blend well-aligned texture into a resulting model. The algorithm can run in both online mode (during the process of acquiring data, for the purpose of real-time reconstruction and visual feedback) and offline mode (when all the data have been acquired).

### SUMMARY OF THE INVENTION

The present invention addresses the problems of online and offline 3d scene reconstruction from RGBD-camera images (especially using IOS Ipad device with attached Structure Sensor). The source data for a scene reconstruction algorithm is a set of pairs of RGB and depth images. Each pair is taken at the same moments of time by an RGB camera and a depth sensor. All pairs correspond to the same static scene with an RGB camera and a depth sensor moving around in space. The output of the algorithm is a 3D model of a scene consisting of a mesh and a texture.

Our new approach for online calibration is based on aligning edges in the depth image with edges in the grey-scale or color image. Edges are sharp changes in depth (for a depth image) or intensity of a grey-scale or color (for color image) correspondingly. We have developed a method that finds this alignment by optimizing a cost function that depends on a set of depth and grey-scale/color image pairs as well as calibration parameters. Relative pose between RGB and depth cameras, RGB intrinsic parameters and optionally depth sensor intrinsic parameters are optimized over all rgb-depth frames to maximize the cost function. Our method requires initial guess for the calibration parameters but is robust to strong noise in the initial guess.

Definitions:
Intrinsic parameters: parameters of RGB camera that define how 3D point map to pixels in an image generated by the camera [10]
Extrinsic parameters: relative location of RGB camera and depth sensor to each other
Calibration: the process of finding either intrinsic or extrinsic parameters or both
Visual odometry: reconstruction of camera trajectory while acquiring data
Sparse bundle adjustment (“SBA”): establishing correspondences between 3D points from different frames and refining their positions in space. It may also include refinement of camera poses and intrinsic/extrinsic parameters too.
Mesh reconstruction: building a surface representation from a point cloud, usually as a set of triangles.
Texture blending: generated a seamless texture map for a surface from images from multiple frames, corresponding to different camera positions in space.
Offline process: throughout this document means it done before or after scanning, but not during scanning. Offline calibration means finding camera and depth sensor parameters before starting the scanning process. Offline reconstruction means the model is reconstructed after the scanning process.
Online process: throughout this document means it is done in real-time during scanning. Online odometry means reconstructing camera trajectory in real-time as a user moves a mobile device.

### BRIEF DESCRIPTION OF DRAWINGS

FIG. 1 shows depth points projected to rgb frames with initial calibration, red lines mark depth edges.

FIG. 2 shows same as FIG. 1 after optimization over 2 rgb-d frames. Depth edges align well to RGB edges.

FIG. 3 shows reconstruction with SBA over 4 images—texture is misaligned at box edges.

FIG. 4 shows SBA with edge optimization added—well aligned texture.

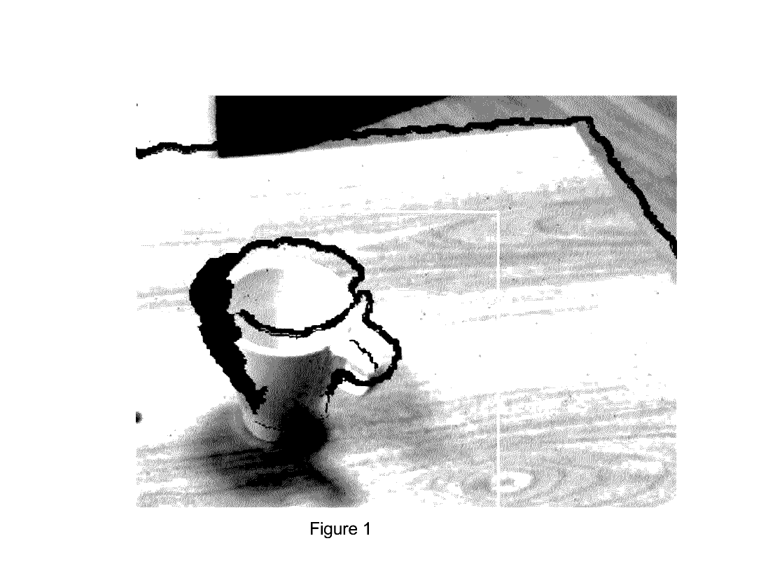

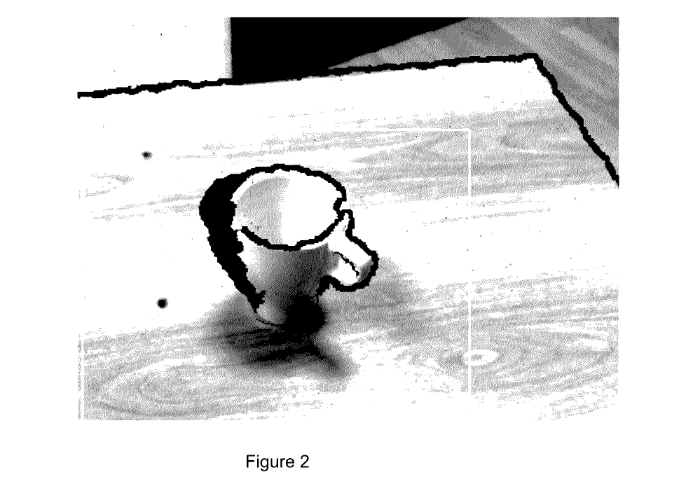

### DESCRIPTION OF EMBODIMENTS

A typical scene reconstruction algorithm consists of the following steps:

1. Visual odometry and SBA

2. Mesh reconstruction from a joint point cloud generated by SBA

3. Texture blending: use the SBA output to establish the positions of camera in different frames with regard to the mesh. Blend several RGB images to create a seamless texture.

Most of the state of the art algorithms [3, 4] assume that all the data is acquired with the same intrinsic/extrinsic parameters. However, it is found that both internal sensor parameters as well as their relative location changes from run to run resulting in a noticeable degradation in the final result.

Good calibration is crucial both for obtaining a good model texture and for RGBD odometry quality. There is no evidence that this problem can be solved with calibration done in advance or even by optimizing camera positions and calibration parameters at the same time with SBA using combined RGB reprojection error and ICP point-to-plane distance cost function similar to [4]. Error in intrinsic and extrinsic parameters leads to a misalignment of texture with a geometric model. The goal of our research was to create an algorithm that a) allows online RGBD calibration that improves with each shot taken, provides maximum quality and robustness given few images or even one image. b) use it for improvement of offline SLAM to find the most accurate calibration parameter values and blend well-aligned texture into a resulting model. The algorithm can run in both online mode (during the process of acquiring data, for the purpose of real-time reconstruction and visual feedback) and offline mode (when all the data have been acquired).

Let us first consider the online calibration problem without SBA.
We define depth edge points on each depth image. A depth image is an image where each pixel encodes a distance from the depth sensor to the corresponding physical object. In each horizontal line of the image we find points such that |d(i+1)−d(i)|>eps*d(i) and take argmin_{{i,i+1}}d(*) and mark them edge points, where d(i)=depth value for the i-th point in the line, and d=0 means depth is not defined due to physical sensor limitation like max range, occlusion etc. We also mark as edges points such that (d(i-k)=..=d(i−1)=0, d(i)>0). We repeat this for vertical lines too. Here we have a set D={d 1, . . . dₙ) of edge points over all images. Any other line finder, such as Sobel filter followed by a threshold can be used instead of the algorithm described in this section.
We convert RGB images to grayscale and define gₓ(x,y)=Σ_{i=x-k . . . x-1}I(i,y)−Σ_{i=x+k . . . x+1}I(i,y), g_{y}(x,y)=Σ_{i=y-k . . . y-1}I(x, i)−Σ_{i=y+k . . . y+1}I(x,i) where I(x,y) is grayscale intensity of a pixel with coordinates (x,y). gₓ(x,y) measures the difference in intensity at (x,y) along horizontal line and gₓ(x,y) along the vertical line, this type of goal function is used to emphasize sharp changes.
We define the cost function that favors projections of depth discontinuities to high gradient areas in the RGB image E=Σ_{i=1 . . . n} (gₓ(p(d i))² +g_{y}(p(d i))²), where p(.) is the function projecting a 3D point into an RGB camera pixel position, over all edge points. Optimization can be done with any optimization method, for example, Levenberg-Marquardt [2]. Optimization is done over 7 parameters (6 DOF extrinsics and RGB camera focal range, in offline mode depth focal range is added too). k controls convergence range (k=20 in our case). Derivatives for gx, gy are approximated as finite differences g(x+1,y)-g(x,y), g(x,y+1)-g(x,y). In the online mode we perform few (3-5) LM iterations for each added RGB/depth image pair. The current implementation that we have takes 0.1-0.3 sec on IPAD Air depending on the number of optimized frames, and we think there is room for optimization that will give about 5-8 times speedup. In the offline mode (with SBA), we add the edge term E to the ICP point-to-plane term and the reprojection error term, allowing to find a non-ambiguous 6 DOF solution for RGB-depth extrinsics even in minimalistic scenes (see pic 3,4).

In order to increase robustness for the online mode with few images, we do the following tests 1) that LM solution does not go far away from the initial approximation. This means that the distance from the initial to new translation, rotation or focal range is greater than a predefined threshold (dependent on a device and bracket type, we use the values of 0.02 for z lement of rotation quaternion, 0.032 for first two elements, 0.028 for 1-st position element, 0.016 cm for 2-nd position element, 20 units for focal range, when we use position optimization and and 36 otherwise, for iPad Air) 2) that covariance matrix in LM step is well conditioned, i.e its condition number or biggest eigenvalue is less than a predefined threshold (so that all DOF are fixed), we use the fixed threshold of 0.05 for smallest eigenvalue of covariance matrix. If those tests fail, we (iteratively) reduce the number of optimized parameters, first fixing focal ranges, then extrinsics translation and then rotation along z axis. Pictures 1, 2 show online calibration performance on 2 frames.

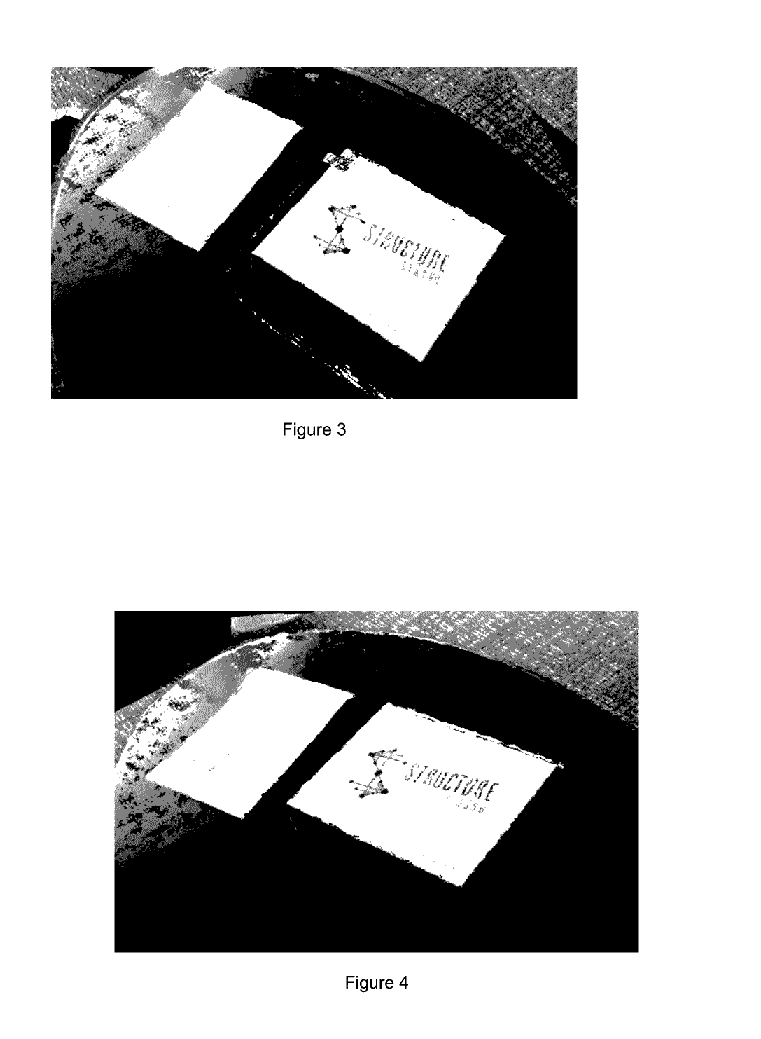

This approach has the following advantages over the prior art: a) in offline auto-calibration approaches, it allows to fix lateral degree of freedom in extrinsic optimization (see FIG. 3, 4) b) it is very fast—edge point detection is done in 2 passes over a depth image and there is no need to detect edges in RGB (which is much less reliable) c) natural handling of RGB edges with different strength which is much faster and more robust than running edge detector with different thresholds and do distance transforms as in [1]. The only drawback is limited convergence basin but this is usually not an issue in our problem as approximate values for calibration parameters are known in advance.

Aligning edges in depth and RGB images for calibration is not novel. However all of the existing methods that we know compute edges in the RGB image explicitly, using one of the existing edge detectors. The cost function for such approaches is based on distance transform for the edge image. Both edge detector and distance transform are expensive to compute. Our major novelty is that we propose a cost function that depends only on intensity of the RGB images and does not require an edge detector and/or distance transform to be computed on each RGB image. The specific cost function we suggested above is both fast to compute, allows good convergence radius, and does not require precomputed distance transforms for each rgb image. Another novelty is combining this edge-based optimization with offline SLAM for maximally accurate estimation of calibration parameters. Also, state of the art approaches use a specific threshold to detect edges, thus either missing weak edges or adding both weak and strong edges with the same weight to the cost function. Our method deals with both weak and strong edges, weighting them appropriately in the cost function, thus not requiring to choose an edge threshold.

### REFERENCES

Liu, Ming-Yu, Oncel Tuzel, Ashok Veeraraghavan, and Rama Chellappa. “Fast directional chamfer matching.” In Computer Vision and Pattern Recognition (CVPR), 2010 IEEE Conference on, pp. 1696-1703. IEEE, 2010.

### ADDITIONAL REFERENCES

1. Paul L. Rosin & Geoff A. W. West “Multi-Scale Salience Distance Transforms” Graphical Models/graphical Models and Image Processing/computer Vision, Graphics, and Image Processing-CVGIP , vol. 57, no. 6, pp. 483-521, 1995
2. Donald Marquardt (1963). “An Algorithm for Least-Squares Estimation of Nonlinear Parameters”. SIAM Journal on Applied Mathematics 11 (2): 431-441.
3. Qian-Yi Zhou and Vladlen Koltun Color Map Optimization for 3D Reconstruction with Consumer Depth Cameras ACM Transactions on Graphics 33(4), 2014
4. “Real-time non-rigid reconstruction using an RGB-D camera” Michael Zollhöfer, Matthias Nieβner, Shahram Izadi, ACM Transactions on Graphics (TOG)-Proceedings of ACM SIGGRAPH 2014 TOG Homepage archive, Volume 33 Issue 4, July 2014 Article No. 156
5. Amberg, Brian, Andrew Blake, Andrew Fitzgibbon, Sami Romdhani, and Thomas Vetter. “Reconstructing high quality face-surfaces using model based stereo.” In Computer Vision, 2007. ICCV 2007. IEEE 11th International Conference on, pp. 1-8. IEEE, 2007.
6. Fitzgibbon, Andrew W. “Robust registration of 2D and 3D point sets.” Image and Vision Computing 21, no. 13 (2003; ): 1145-1153.
7. Qian-Yi Zhou Vladlen Koltun “Simultaneous Localization and Calibration : Self-Calibration of Consumer Depth Cameras”, CVPR,2014
8. Alex Teichman Stephen Miller Sebastian Thrun “Unsupervised intrinsic calibration of depth sensors via SLAM” Proc. of the IEEE/RSJ International Conference on Intelligent Robots and Systems (IROS), 2013
9. Agostino Martinelli, Nicola Tomatis , Roland Siegwart “Simultaneous localization and odometry self-calibration for mobile robot” , Autonomous Robots January 2007, Volume 22, Issue 1, pp. 75-85
10. Hartley, R., Zisserman, A.: Multiple View Geometry in Computer Vision. Cambridge University Press, Cambridge, 2000

1. A method of producing a 3-dimensional model of a scene comprising the steps of:
a) providing a source data having at least one pair of RGB and depth images taken at the same moment in time;
b) calibrating by aligning edges in the depth image with the edges in the RGB image;
c) conducting visual odometry and sparse bundle adjustment from the source data to generate a joint point cloud;
d) conducting a mesh reconstruction from the joint point cloud to produce a surface representation; and
e) generating a texture blending from the surface representation to produce the 3-dimensional model of a scene.

2. The method of claim 1, wherein the step of calibrating comprises:
a) defining depth edge points in each depth image;
b) converting the RGB image to gray scale and identify high intensity gradient areas; and
c) aligning the depth edge points with the high intensity gradient areas.
